(19) United States
(12) Patent Application Publication
(10) Pub. No.: US 2009/0039638 A1
(43) Pub. Date: Feb. 12, 2009

(54) Memo Pad Structure

(76) Inventor: David C.T. JOUR, Taipei (TW)

Correspondence Address: CHINE-HUA CHEN, 13056 TOWN COMMONS DR., GERMANTOWN, MD, 20874, US

(21) Appl. No.: 11/834,690

(22) Filed: Aug. 7, 2007

(51) Int. Cl. B42D 17/00

(52) U.S. Cl. 281/44

(57) ABSTRACT

The invention is related to a new memo pad structure that is lightweight, portable and convenient. Its fixation base has an ergonomic rising slope, on which there are a plurality of memo pad stacks. Each memo pad stack is composed of a plurality of single memo pads adhesively bonded together. The memo pad stacks are lined up on the slope and stick out of the high side of the slope to facilitate the peeling. Besides, the memo pad stacks can be made in different colors or with different surface patterns for the purposes of identification, aesthetics and classification.

### BACKGROUND OF THE INVENTION

1. Field of the Invention

The invention is related to a new memo pad structure. Especially it refers to a light, portable and agronomic memo pad structure. Further, the invention provides different colors or local patterns to increase aesthetic and visual effect.

2. Description of the Prior Art

It is common for people to use memo pads in workplace, for emergency contact, messages, reply and reminder et al. Usually memo pads are a stack of a plurality of paper sheets in a certain size. Their back has self-stick adhesive in partial area. The pads are placed into a rectangle fixation base. Thus, the user can peel the pad off, put texts on it, and post it in a place that can be easily noticed. Or the user can stick the pad to the edge of a file folder to note the document category on it. The memo pads provide multiple application functions.

The traditional memo pads as described above and their fixation base does not seem to have a big problem when they are in use. Most people already accept them. However, a product with simple function and no attractive features tends to be replaced and out of the market. Although some people attempt to attract consumers' attention and increase market share by changing the appearance of the fixation base, they do not quite succeed. The biggest drawback for the memo pads on a fixation base is the difficulty in getting a single memo pad. Therefore, further improvement is necessary.

In view of the drawback for the design of traditional memo pads and their fixation base, the inventor was devoted to improving memo pads and a new memo pad structure.

### SUMMARY OF THE INVENTION

The objective for the invention is to provide a memo pad structure that is simple, convenient and argonomic and able to overcome the difficulty in use of current memo pads and increase their usability.

Another objective for the invention is to provide a memo pad structure that is simple, convenient and argonomic and able to increase aesthetic and visual effect.

To attain the above objectives, the memo pad structure for the invention includes a fixation base and a plurality of memo pads on the fixation base. The fixation base is shaped in a thin sheet and forms a argonomic slope from one side to the other. On the slope there are many memo pad stacks. Each memo pad stack is made of a plurality of memo pads adhesively bonded partially and located on the slope, and sticking out on the high side of the slope. In this way, the single memo pad can be peeled off conveniently.

The following preferred embodiment with figures is to provide detailed description for patent examiners to further understand the functions and features for the invention.

### BRIEF DESCRIPTION OF THE DRAWINGS

FIG. 1 is a three dimensional disassembly diagram for a preferred embodiment of the invention.

FIG. 2 is a three dimensional diagram for a preferred embodiment of the invention.

FIG. 3 is a three dimensional diagram for a preferred embodiment of the invention in use.

### DETAILED DESCRIPTION OF THE PREFERRED EMBODIMENTS

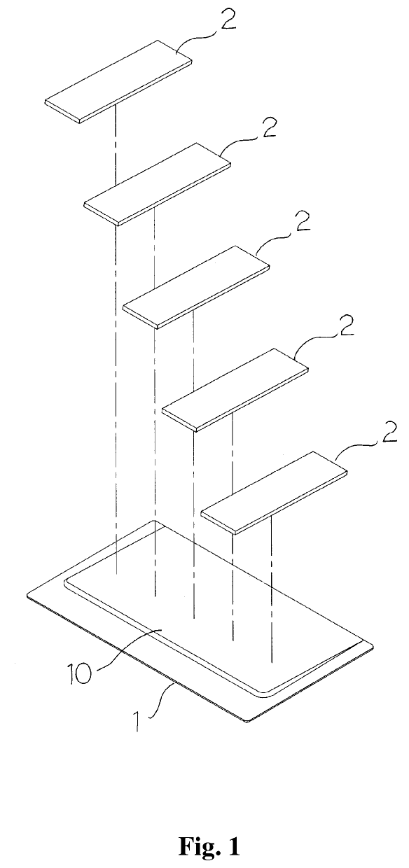

Please refer to FIG. 1 for a preferred embodiment for the new memo pad structure, which includes a fixation base (1) and several memo pad stacks (2) attached on it.

The fixation base (1) is made of hard plastics in thin flat sheet which surface is an ergonomic slope (10) that rises from one side to the other.

A plurality of memo pad stacks (2) are lined up on the slope (10) of the fixation base (1). Their one end sticks out of the slope (10) on the high side to facilitate peeling off a single pad. Each memo pad stack (2) is composed of a plurality of single memo pads (20) partially bonded together.

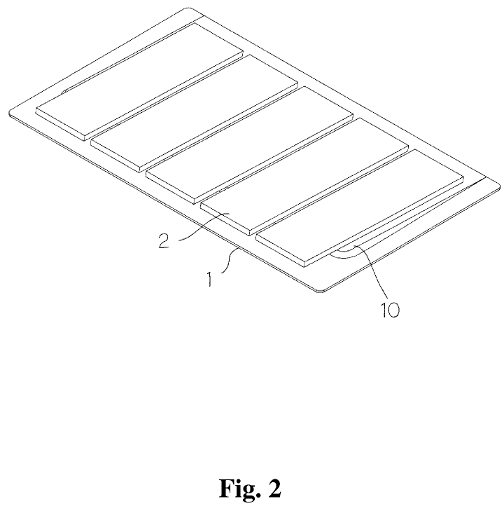

Such an integrated, lightweight and convenient memo pad structure is shown in FIG. 2.

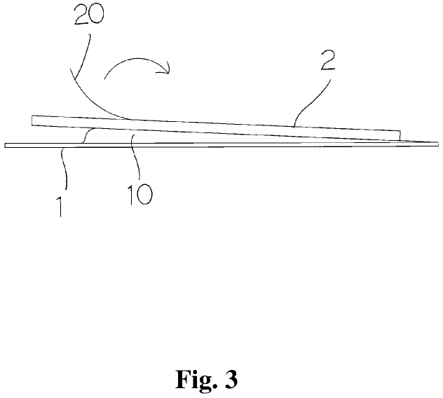

Please refer to FIG. 3. When the above memo pad structure is in use, the user picks one memo pad stack (2) and peels off one single memo pad (20). The user's hand lifts up one memo pad stack (2) and peels off the outermost single memo pad (20). The pad can be attached to a designated object through its back adhesive. All the memo pads of the memo pad stack (2) will be peeled off and used one by one in this way.

On the other side, the memo pad stacks (2) can be made in different colors or with different surface patterns on the pad (20). Such design is to not only increase the overall aesthetic and visual effect but also provide choices for users for the purposes of distinguishing and classification, as additional function and value to the product.

In summary, the invention is an innovation that has not been found in this field. It shall meet the patent requirements.

The above example is only one preferred embodiment for the invention. Those structural modifications with the equivalent effect to the invention shall be considered to fall into the claims by the invention.

What is claimed is:

1. A new memo pad structure includes:
a fixation base, made of hard plastics in thin flat sheet which surface is an ergonomic slope that rises from one side to the other and a plurality of memo pad stacks that are lined up on the slope of the fixation base; one end of the stack sticks out of the slope on the high side to facilitate peeling off a single pad; and each memo pad stack is composed of a plurality of single memo pads partially bonded together.

2. As described in claim 1 for a new memo pad structure, the memo pad stacks can be made into different colors or with different surface patterns.
